(19) United States
(12) Patent Application Publication
(10) Pub. No.: US 2008/0086242 A1
(43) Pub. Date: Apr. 10, 2008

(54) Motor Vehicle Key

(75) Inventors: Ian Bennett, Portola Valley, CA (US); Daniel Rosario, Santa Cruz, CA (US); Pao Hsu Chen, Milpitas, CA (US); Venkat Srinivasan, Stanford, CA (US); Arne Stoschek, Palo Alto, CA (US)

Correspondence Address: MANFRED BECK, P.A., 830 TYLER STREET, HOLLYWOOD, FL, 33019-1327, US

(73) Assignees: VOLKSWAGEN OF AMERICA, INC., Auburn Hills, MI (US); AUDI AG, Ingolstadt (DE)

(21) Appl. No.: 11/869,730

(22) Filed: Oct. 9, 2007

Related U.S. Application Data
(60) Provisional application No. 60/850,491, filed on Oct. 10, 2006.

(51) Int. Cl. G06F 19/00

(52) U.S. Cl. 701/2

(57) ABSTRACT

A motor vehicle key for locking or unlocking a door of a motor vehicle or for operating the motor vehicle includes a display configuration for displaying information which relates to the motor vehicle or for displaying the function of an operator control element of the motor vehicle key. The display configuration includes at least a MEMS display, a cholesteric display and/or an electrophoretic display.

### CROSS-REFERENCE TO RELATED APPLICATIONS

This application claims the benefit of the filing of U.S. Provisional Application No. 60/850,491, filed on Oct. 10, 2006, entitled “Motor Vehicle Key”, which is herewith incorporated by reference in its entirety.

### BACKGROUND OF THE INVENTION

### Field of the Invention

The invention relates to a motor vehicle key for locking and/or unlocking a door of a motor vehicle and/or for operating the motor vehicle, the motor vehicle key having a display configuration for displaying information which relates to the motor vehicle.

### SUMMARY OF THE INVENTION

It is an object of the invention to provide a motor vehicle key with an improved display configuration. It is in particular an object of the invention to improve the readability of information which is displayed on a motor vehicle key. A further object of the invention is to display as much information as possible on a motor vehicle key.

With the foregoing and other objects in view there is provided, in accordance with the invention, in combination with a motor vehicle having a vehicle door, a motor vehicle key configuration, including:

a motor vehicle key configured for a function selected from the group consisting of locking the vehicle door, unlocking the vehicle door and operating the motor vehicle;

the motor vehicle key including an operator control element and a display configuration for displaying information selected from the group consisting of information related to the motor vehicle and information indicating a function of the operator control element; and

the display configuration including at least a display selected from the group consisting of a bistable MEMS display, a cholesteric display and an electrophoretic display.

In other words, the above-mentioned object is achieved by a motor vehicle key for locking and/or unlocking a door of a motor vehicle and/or for operating the motor vehicle, with the motor vehicle key including a display configuration for displaying information which relates to the motor vehicle and/or for displaying the function of an operator control element of the motor vehicle key, and with the display configuration including at least a bistable MEMS (microelectromechanical system) display, a cholesteric display and/or an electrophoretic display. In this way, on account of the extremely low or non-existent energy requirement by this display when information is statically displayed, a particularly large display can be used, so that the displayed information can be easily read and so that a large amount of information can be displayed.

In accordance with the invention, information which relates to the motor vehicle can include, in particular, the tank filling level, the locking state of the motor vehicle, the remaining range of the motor vehicle, the status of an alarm system of the motor vehicle, the location of the motor vehicle (absolute or in relation to the motor vehicle key), the license number of the motor vehicle, the manufacturer of the motor vehicle, the model of the motor vehicle, or the like.

A bistable MEMS display in the above-mentioned sense should in particular not be a MEMS display which is to be used in conjunction with an active light source, as disclosed, for example, in the article “Micro-optical Components for a MEMS Integrated Display” found at the Internet address http://www.ee.washington.edu/research/mems/publications/2003/conferences/iwpsd-kwang-03.pdf.

A suitable bistable MEMS display is for example disclosed on page 22 of the presentation “EE 7382 Introduction to MEMS” (incorporated by reference) which is found at the Internet address http://www.utdallas.edu/˜jblee/EE7382/31%20MEMS%20displays.pdf. Suitable bistable MEMS displays can be acquired, for example, from QUALCOMM INC. (cf., for example, the Internet addresses http://www.qualcomm.com/qmt/technology/index.html and http://www.electronicstalk.com/news/dal/dal118.html). A bistable MEMS display within the meaning of the invention is, in particular, an electrostatically adjustable (electrostatically driven) bistable MEMS display.

Details regarding cholesteric displays and suitable cholesteric displays can be found, for example, in the article “Bistable Reflective Cholesteric Displays” (incorporated by reference) which is found at the Internet address http://www.kentdisplays.com/tech/papers/2003/09-03-IDRC-Bistable%20Reflective%20Cholesteric%20Displays.pdf. Details regarding electrophoretic displays and suitable electrophoretic displays can be found, for example, in the article “Electrophoretic Display Technology”: The beginnings, the improvements, and a future in flexible electronics” (incorporated by reference) found at the Internet address http://people.ccmr.cornell.edu/˜cober/mse542/page2/files/Herz%20Electrophoretics.pdf. Further details regarding electrophoretic displays can be found, for example, at the Internet address http://www.testticker.de/pcpro/praxis/peripherie/article200203195023.aspx. Electrophoretic displays can be arranged on thin flexible plastic supports.

According to another feature of the invention, the display configuration has no light source for actively emitting light disposed underneath the display. In other words, the display configuration does not include a light source, which is disposed beneath the display, for actively emitting light.

According to yet another feature of the invention, the display is a bistable display.

According to a further feature of the invention, the display is a reflective display.

With the objects of the invention in view there is also provided, in combination with a motor vehicle having a vehicle door, a motor vehicle key configuration, including:

a motor vehicle key configured for a function selected from the group consisting of locking the vehicle door, unlocking the vehicle door and operating the motor vehicle;

the motor vehicle key including an operator control element and a display configuration for displaying information selected from the group consisting of information related to the motor vehicle and information indicating a function of the operator control element; and

the display configuration including at least a quasistatic reflective display.

According to another feature of the invention, the quasistatic reflective display is a pigment-free display.

According to yet another feature of the invention, the quasistatic reflective display is a bistable display.

In other words, the above-mentioned object is also achieved by a motor vehicle key for locking and/or unlocking a door of a motor vehicle and/or for operating the motor vehicle, with the motor vehicle key including a display configuration for displaying information which relates to the motor vehicle and/or for displaying the function of an operator control element of the motor vehicle key, and with the display configuration including at least a quasistatic reflective display. In this way, on account of the extremely low or non-existent energy requirement by the display when information is statically displayed, a particularly large display can be used, so that the displayed information can be easily read and/or so that a large amount of information can be displayed. A quasistatic reflective display can be implemented as a MEMS display, as a cholesteric display and/or as an electrophoretic display.

A reflective display within the meaning of the invention is, in particular, a display without an associated light source. A reflective display within the meaning of the invention is, in particular, a display which can be (easily) read in daylight without an additional light source. A quasistatic display within the meaning of the invention is in particular a display whose display content can be changed but which does not consume any energy or any appreciable energy or consumes virtually no energy when the display content remains unchanged. When the display content remains unchanged, a display consumes in particular no appreciable energy when the energy in a rechargeable battery in a (customary) motor vehicle key is sufficient to maintain the display for many or several hundred hours. When the display content remains unchanged, a display consumes, in particular, no appreciable energy when the energy consumption is considerably lower than the energy consumption for a locking or unlocking function when the motor vehicle key is used as is customary.

In accordance with an embodiment of the invention, the display is pigment-free. In accordance with a further embodiment of the invention, the display is bistable. A bistable display within the meaning of the invention is, in particular, a display with two stable states which differ from one another. In this sense, a stable state is a state in which the display does not consume any energy or any appreciable energy or consumes virtually no energy. In contrast, energy is required in particular when changing over from one state to the other state.

With the objects of the invention in view there is further provided, in combination with a motor vehicle having a vehicle door, a motor vehicle key configuration, including:

a motor vehicle key configured for a function selected from the group consisting of locking the vehicle door, unlocking the vehicle door and operating the motor vehicle;

the motor vehicle key including an operator control element and a display configuration for displaying information selected from the group consisting of information related to the motor vehicle and information indicating a function of the operator control element; and

the display configuration including at least a bistable display.

In other words, the above-mentioned object is furthermore achieved by a motor vehicle key for locking and/or unlocking a door of a motor vehicle and/or for operating the motor vehicle, with the motor vehicle key including a display configuration for displaying information which relates to the motor vehicle and/or for displaying the function of an operator control element of the motor vehicle key, and with the display configuration including at least a bistable display. In this way, on account of the extremely low or non-existent energy requirement by the display when information is statically displayed, a particularly large display can be used, so that the displayed information can be easily read and/or so that a large amount of information can be displayed.

The above-mentioned displays are, in particular, matrix displays. The above-mentioned displays are, in particular, displays with pixels which can be controlled independently of one another, so that changeable and freely configurable images can be displayed. A motor vehicle within the meaning of the invention is, in particular, a land vehicle which can be individually used on roads. Motor vehicles within the meaning of the invention are, in particular, not restricted to land vehicles with an internal combustion engine.

Other features which are considered as characteristic for the invention are set forth in the appended claims.

Although the invention is illustrated and described herein as embodied in a motor vehicle key, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram of an exemplary embodiment of a motor vehicle key for locking and/or unlocking a door of a motor vehicle and/or for operating the motor vehicle in accordance with the invention;

FIG. 2 is a diagrammatic perspective view of a further exemplary embodiment of a motor vehicle key for locking and/or unlocking a door of a motor vehicle and/or for operating the motor vehicle in accordance with the invention;

FIG. 3 is a diagrammatic perspective view of a further exemplary embodiment of a motor vehicle key for locking and/or unlocking a door of a motor vehicle and/or for operating the motor vehicle in accordance with the invention;

FIG. 4 is a diagrammatic perspective view of an exemplary embodiment of a display configuration according to the invention;

FIG. 5 is a diagrammatic sectional view of an exemplary embodiment of an electrophoretic display according to the invention;

FIG. 6 is a diagrammatic perspective view of an exemplary embodiment of a bistable MEMS display according to the invention in a state which is called the “open state”; and

FIG. 7 is a diagrammatic perspective view of the bistable MEMS display according to FIG. 6 in a state which is called the “collapsed state”.

### DESCRIPTION OF THE PREFERRED EMBODIMENTS

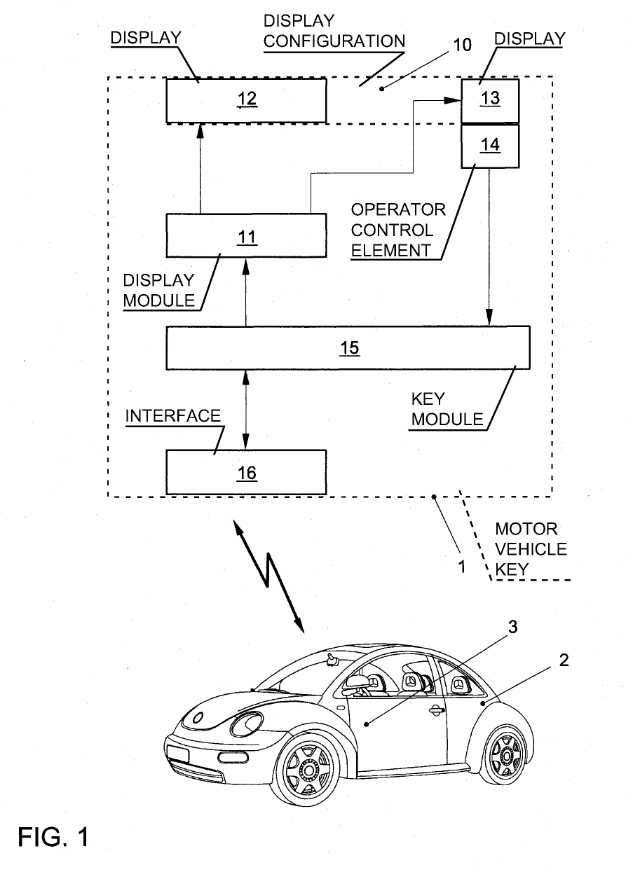

Referring now to the figures of the drawings and first, particularly, to FIG. 1 thereof, there is shown a basic illustration of an exemplary embodiment of a motor vehicle key or key fob 1 for locking and/or unlocking a door 3 of a motor vehicle 2 and/or for operating the motor vehicle 2. The motor vehicle key 1 includes a display configuration 10 for displaying information which relates to the motor vehicle 2 and/or for displaying the function of an operator control element 14 of the motor vehicle key 1. Information which relates to the motor vehicle 2 can include the tank filling level, the locking state of the motor vehicle 2, the remaining range of the motor vehicle 2, the status of an alarm system of the motor vehicle 2, the location of the motor vehicle 2 (absolute or in relation to the motor vehicle key 1), the license number of the motor vehicle 2, the manufacturer of the motor vehicle 2 and/or the model of the motor vehicle 2.

The display configuration 10 includes two quasistatic reflective or bistable displays 12 and 13. A reflective display in this sense is, in particular, a display which can be read in daylight without an additional light source. A quasistatic display in this sense is, in particular, a display whose display content can be changed but which consumes no energy or no appreciable energy or consumes virtually no energy when the display content remains unchanged. When the display content remains unchanged, a display consumes, in particular, no appreciable energy when the energy of a rechargeable battery of the motor vehicle key 1 is sufficient to maintain the display for many or several hundred hours. A protective layer or cover, in particular a sliding cover, can be provided in order to protect the display configuration 10 and/or the displays 12 and 13.

The display configuration 10 has an associated display module 11 through the use of which the displays 12 and 13 can be controlled in such a way that they display the desired information. The display module 11 can also be part of the display configuration 10.

The motor vehicle key 1 furthermore includes a key module 15 and an, in particular wireless, interface 16 to the motor vehicle 2 for implementing functions such as locking and/or unlocking of the motor vehicle 2 and/or authorized operation of the motor vehicle 2. The motor vehicle key 1 can additionally include a, for example GPS-based (Global Positioning System), locating or navigation system and/or an RFID (Radio Frequency Identification) module.

Furthermore, the motor vehicle key 1 may include a power supply with one or more disposable batteries and/or with one or more rechargeable batteries. Provision can be made for the power supply for a locating or navigation system to be independent of the power supply for the key module 15 and the interface 16 and also for the display module 11. A system for generating electrical energy can also be provided. A system of this type can convert, for example, heat, sunlight (solar energy) or kinetic energy into electrical energy. An energy transmission interface, in particular a wireless energy transmission interface, for transmitting electrical energy from the motor vehicle 2 to the motor vehicle key 1 may also be provided.

The information to be displayed by the display configuration 10 is transmitted via the interface 16 or a further interface. Transmission can be performed, for example, via an electrical connection, for example through the use of USB (Universal Serial Bus) or FIREWIRE, or in a wireless manner, for example through the use of BLUETOOTH or RF. Provision is particularly made for the information which is provided for transmission purposes to be transmitted when the engine of the motor vehicle 2 is being turned off.

The motor vehicle key 1 can include an additional lighting device for illuminating the display configuration 10 in the dark, and also a switch or the like for switching on and switching off the additional lighting device.

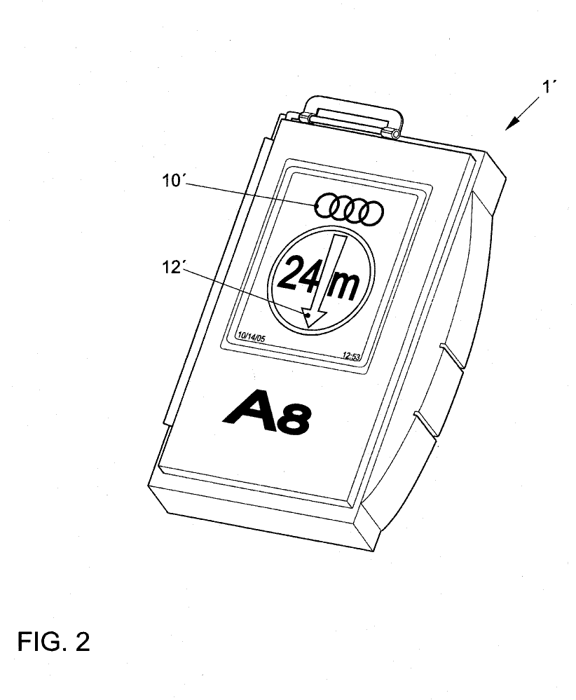

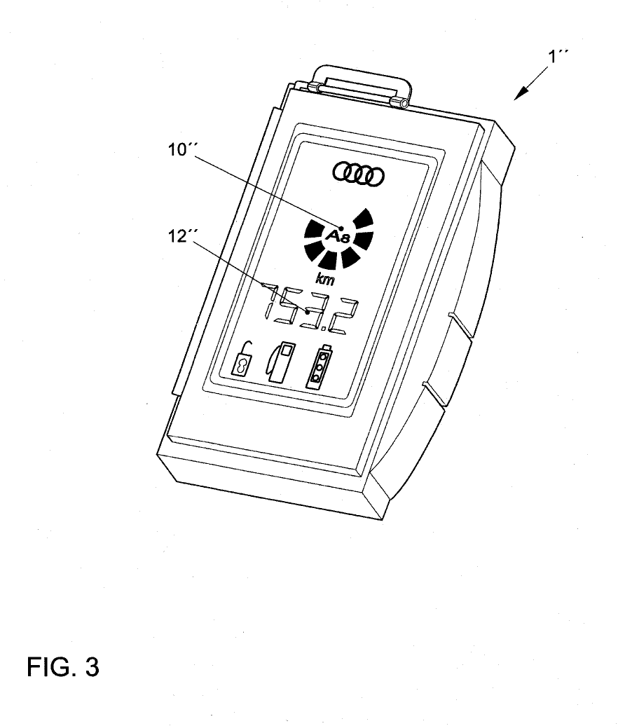

FIG. 2 and FIG. 3 show perspective views of further exemplary embodiments of a motor vehicle key 1′ and, respectively, 1″ for locking and/or unlocking the door of a motor vehicle and/or for operating the motor vehicle. Reference symbols 10′ and 10″ denote respective display configurations with a respective display 12′ and 12″. A motor vehicle key of this type has been developed for a motor vehicle from AUDI.

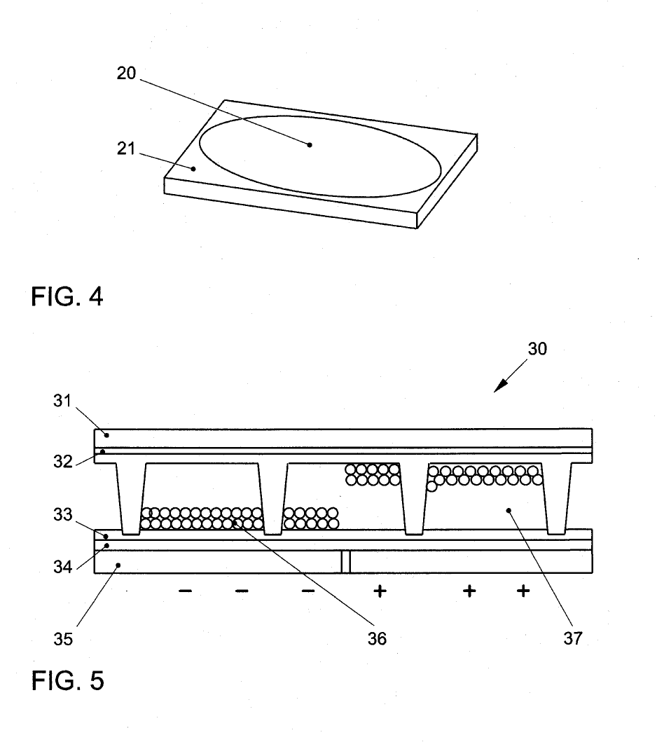

FIG. 4 shows an exemplary embodiment of a display configuration. The display configuration includes a display 20 and a masking layer 21 which is arranged over the display 20 and reduces the rectangular display area of the display 20 to an oval.

A display 12, 13, 12′, 12″ or 20 can be implemented or configured as a bistable MEMS display, as a cholesteric display and/or as an electrophoretic display. Details regarding electrophoretic displays and suitable electrophoretic displays can be found, for example, in the article “Electrophoretic Display Technology: The beginnings, the improvements, and a future in flexible electronics” (incorporated by reference) found at the Internet address http://people.ccmr.cornell.edu/˜cober/mse542/page2/files/Herz%20Electrophoretics.pdf. Further details regarding electrophoretic displays can be found, for example, at the Internet address http://www.testticker.de/pcpro/praxis/peripherie/article200203195023.aspx.

FIG. 5 shows an exemplary embodiment of an electrophoretic display 30. In FIG. 5, reference symbol 31 denotes a PET (polyethylene terephthalate) protective layer beneath which a transparent conductor 32 is disposed. Chambers which are sealed by a sealing layer 33 and contain a dielectric fluid 37 with charged particles 36 are disposed beneath the transparent conductor 32. The sealing layer 33 is connected to a patterned conductor 35 through the use of an adhesive layer 34. The position of the charged particles 36 in their chambers can be changed by charging the patterned conductor 35.

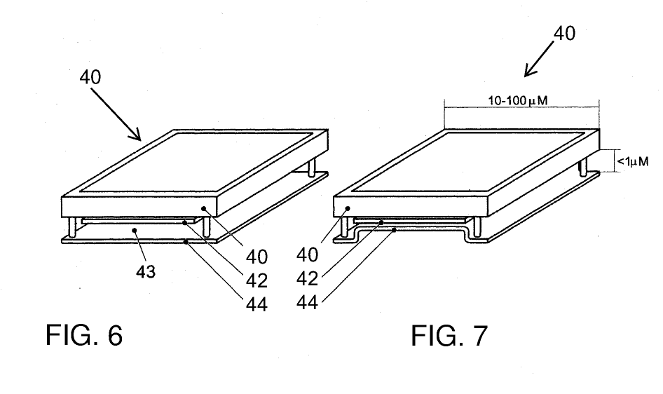

A suitable bistable MEMS display is disclosed, for example, on page 22 of the presentation “EE 7382 Introduction to MEMS” (incorporated by reference) which is found at the Internet address http://www.utdallas.edu/˜jblee/EE7382/31%20MEMS%20displays.pdf. Suitable bistable MEMS displays can be acquired, for example, from QUALCOMM INC. (cf., for example, the Internet addresses http://www.qualcomm.com/qmt/technology/index.html and http://www.electronicstalk.com/news/dal/dal118.html). A bistable MEMS display is, in particular, an electrostatically adjustable bistable MEMS display. FIG. 6 shows an exemplary embodiment of a pixel 40 of a bistable MEMS display in a state which is called the “open state”, and FIG. 7 shows the pixel 40 of the bistable MEMS display in a state which is called the “collapsed state”. The pixel 40 of the bistable MEMS display includes a glass substrate 41 beneath which an electrode 42 is arranged. A membrane 44 is arranged beneath the electrode. In the state which is called the “open state”, there is an air gap 43 between the electrode 42 and the membrane 44. The membrane 44 bridges the air gap 43 (“collapsed state”) by applying a suitable voltage.

Details regarding cholesteric displays and suitable cholesteric displays can be found, for example, in the article “Bistable Reflective Cholesteric Displays” (incorporated by reference) which is found at the Internet address http://www.kentdisplays.com/tech/papers/2003/09-03-IDRC-Bistable%20Reflective%20Cholesteric%20Displays.pdf.

The elements and layers in the figures have been drawn with a view to simplicity and clarity and not necessarily true to scale. For example, the sizes of some elements and/or layers are therefore exaggerated compared to other elements and/or layers in order to improve understanding of the exemplary embodiments of the present invention.

### LIST OF REFERENCE SYMBOLS

1, 1′, 1″ Motor vehicle key
2 Motor vehicle
3 Door
10, 10′, 10″ Display configuration
11 Display module
12, 13, 12′, 12″, 20 Display
14 Operator control element
15 Key module
16 Interface
21 Masking layer
30 Electrophoretic display
31 PET protective layer
32 Transparent conductor
33 Sealing layer
34 Adhesive layer
35 Patterned conductor
36 Charged particles
37 Dielectric fluid
40 Pixel of a bistable MEMS display
41 Glass substrate
42 Electrode
43 Air gap
44 Membrane

What is claimed is:

1. In combination with a motor vehicle having a vehicle door, a motor vehicle key configuration, comprising:
a motor vehicle key configured for a function selected from the group consisting of locking the vehicle door, unlocking the vehicle door and operating the motor vehicle;
said motor vehicle key including an operator control element and a display configuration for displaying information selected from the group consisting of information related to the motor vehicle and information indicating a function of said operator control element; and
said display configuration including at least a display selected from the group consisting of a bistable MEMS display, a cholesteric display and an electrophoretic display.

2. The vehicle key configuration according to claim 1, wherein said display configuration has no light source for actively emitting light disposed underneath said display.

3. The vehicle key configuration according to claim 1, wherein said display is a bistable display.

4. The vehicle key configuration according to claim 1, wherein said display is a reflective display.

5. The vehicle key configuration according to claim 1, wherein said display is a pigment-free display.

6. In combination with a motor vehicle having a vehicle door, a motor vehicle key configuration, comprising:
a motor vehicle key configured for a function selected from the group consisting of locking the vehicle door, unlocking the vehicle door and operating the motor vehicle;
said motor vehicle key including an operator control element and a display configuration for displaying information selected from the group consisting of information related to the motor vehicle and information indicating a function of said operator control element; and
said display configuration including at least a quasistatic reflective display.

7. The vehicle key configuration according to claim 6, wherein said quasistatic reflective display is a pigment-free display.

8. The vehicle key configuration according to claim 6, wherein said quasistatic reflective display is a bistable display.

9. In combination with a motor vehicle having a vehicle door, a motor vehicle key configuration, comprising:
a motor vehicle key configured for a function selected from the group consisting of locking the vehicle door, unlocking the vehicle door and operating the motor vehicle;
said motor vehicle key including an operator control element and a display configuration for displaying information selected from the group consisting of information related to the motor vehicle and information indicating a function of said operator control element; and
said display configuration including at least a bistable display.
